(19) United States
(12) Patent Application Publication
(10) Pub. No.: US 2010/0326778 A1
(43) Pub. Date: Dec. 30, 2010

(54) Brake pedal simulator and brake system

(75) Inventors: Andreas Schriebl, Gossendorf (AT); Daniel Lindvai-Soos, Graz (AT); Peter Del-Negro, St. Radegund/Graz (AT); Ingo Crillovich-Cocoglia, Gleisdorf (AT); Stefan Reinbacher, Ligist (AT); Peter Zotter, Lodersdorf (AT)

Correspondence Address: HARNESS, DICKEY & PIERCE, P.L.C., P.O. BOX 828, BLOOMFIELD HILLS, MI, 48303, US

(73) Assignee: MAGNA Powertrain AG & Co KG, Lannach (AT)

(21) Appl. No.: 12/789,572

(22) Filed: May 28, 2010

(30) Foreign Application Priority Data
May 29, 2009 (DE) 10 2009 023 369.5

(51) Int. Cl. F16D 65/36; B60T 7/04; B60T 13/74; B60T 13/66; B60T 15/00

(52) U.S. Cl. 188/106 P

(57) ABSTRACT

A brake pedal simulator for a brake system of a motor vehicle has a chamber with hydraulic fluid which is limited by a first piston coupled to a brake pedal, a second piston having restoring means for producing a restoring force, and a third piston driving a pressure transducer. The first and second pistons are functionally connected together by the hydraulic fluid when a first valve is open to transmit the restoring force to the first piston upon movement against the hydraulic fluid. This first functional connection is interrupted when the first valve is closed. The first and second pistons are functionally connected together by the hydraulic fluid when a second valve is open to transmit movement of the first piston to the third piston. This second functional connection is interrupted when the second valve is closed.

### CROSS-REFERENCE TO RELATED APPLICATIONS

This application is based on and claims priority to German Patent Application No. 10 2009 023 369.5 filed with the German Patent Office on May 29, 2009, the entire contents of which are hereby incorporated by reference.

### FIELD

The invention relates to a brake pedal simulator for a brake system of a motor vehicle having a chamber filled with hydraulic fluid, which is limited by a first piston capable of being coupled in particular with a brake pedal and by a second piston, and having a restoring means acting on the second piston for the production of a restoring force. In addition, the invention relates in particular to an electrohydraulic brake system for a motor vehicle having a brake pedal simulator of the kind mentioned at the beginning.

### BACKGROUND

In a brake-by-wire brake system, during a so-called brake-by-wire mode of operation, the required braking moment is produced without direct transmission of the physical force of the vehicle operator on a brake pressure transducer because the transducer of the brake system is actuated by an electrical drive unit. At the same time, a brake pedal simulator coupled with the brake system simulates a pedal characteristic corresponding to a braking operation and so acts to give the vehicle operator the customary brake pedal feel. In case of failure of the brake-by-wire mode of operation, the brake system is operated in a so-called emergency mode of operation. There, the physical force exerted by the operator on the brake pedal is transmitted directly to the brake pressure transducer so as to initiate a braking operation.

### SUMMARY

The object of the invention is to refine a brake pedal simulator of the kind mentioned at the beginning so that it is simple and inexpensive to produce. This object is accomplished by the features of the invention and, in particular, in that a chamber of the brake pedal simulator has a first chamber section and a second chamber section, wherein the first chamber section extends between a first valve and the first piston and wherein the second chamber section extends between the first valve and the second piston. The first piston and the second piston are functionally connected together by the hydraulic fluid when the first valve is open so as to transmit the restoring force produced by a restoring means to the first piston upon a movement of the first piston against the hydraulic fluid, and wherein the functional connection between the first piston and the second piston is interrupted when the first valve is closed.

Owing to the first valve arranged between the two chamber sections, the restoring means can be coupled in simple and inexpensive fashion with the first piston, which preferably is designed to be functionally connected with a brake pedal, while the first valve is open and decoupled while the first valve is closed. Therefore, the brake pedal simulator according to the invention is especially well-suited for use in brake-by-wire brake systems, since a brake pedal simulator according to the invention can be coupled with the brake system and/or decoupled from the brake system merely by switching of the first valve.

In addition, the chamber has a second valve and a third chamber section which extends between the second valve and a third piston, which is in particular provided for driving a brake pressure transducer of the brake system. There, the first chamber section extends between the first piston and the second valve. When the second valve is open, the first piston and the third piston are functionally connected together by the hydraulic fluid so as to transmit a movement of the first piston to the third piston. In contrast, the functional connection between the first and third piston is interrupted when the second valve is closed.

By appropriate switching of the second valve, a movement of the first piston, which in the installed state of the brake pedal simulator in a brake system preferably is in functional connection with the brake pedal, can therefore be transmitted to the third piston which, in the installed state, is preferably used for drive of the hydraulic pressure transducer of the brake system. When the brake pedal simulator according to the invention is used in a brake-by-wire brake system, a coupling between the first piston and the third piston can therefore be obtained in simple fashion during emergency operation, so that the physical force exerted by the vehicle operator on the brake pedal can be transmitted directly to the brake pressure transducer, so as to initiate a braking operation.

According to a preferred development of the invention, the brake pedal simulator is designed in such a way that the second valve is closed when the first valve is open, and vice-versa.

The first valve preferably is a currentless closed directional control valve. In addition, the second valve preferably is a currentless open directional control valve. Accordingly, the first valve is closed when it is not supplied with electric current, while the second valve is open. Such a brake pedal simulator can be used especially well in a brake-by-wire brake system, in which the brake system is operated currentless during emergency operation, because it is ensured by the brake pedal simulator during emergency operation that the first piston is in functional connection with the third piston, while the functional connection between the first and second piston is interrupted, so that the restoring means is decoupled from the brake system.

Further, a third valve may be arranged on the brake pedal simulator which separates the third chamber section from a reservoir for the hydraulic fluid. The third valve preferably is open when the second valve is closed, and vice-versa.

The reservoir for hydraulic fluid preferably may be a brake fluid container of a power brake. This design has the advantage that a brake fluid container already present can also be used in this second function as a hydraulic fluid reservoir for the brake pedal simulator. Further, warning indicators already present in this embodiment concerning, for instance, the status of the brake fluid, can also be used as a warning indicator for the brake pedal simulator.

The third valve is preferably a currentless closed directional control valve. Here, it is advantageous that when the third valve is open, hydraulic fluid can flow from the reservoir into the third chamber section when the third piston, with the second valve closed, is moved in such a way that the volume of the third chamber section is enlarged. There, it is further advantageous that hydraulic fluid can flow into the reservoir when the volume of the third chamber section is reduced by a corresponding movement of the third piston. In this respect, a diminished pressure or an excess pressure in the third chamber section is prevented in simple fashion.

The design of the first valve and/or the second valve and/or the third valve as directional control valve has the added advantage that they can be switched with little electric power.

According to an additional embodiment of the invention, the first valve and the second valve are designed in the form of a single 3/2-way valve, so that, depending upon the position of the 3/2-way valve, the first piston and the second piston or the first piston and the third piston are functionally connected together by the hydraulic fluid. The 3/2-way valve may be designed in a variety of models, for example as a slide valve. This form of execution has the advantage that the expenditure of material and hence the costs of the brake pedal simulator are reduced.

According to another embodiment of the invention, the first valve and the second valve and the third valve are designed as a single 4/2-way valve so that, depending upon the position of the 4/2-way valve, the first piston is functionally connected together by the hydraulic fluid with the second piston and the reservoir for the hydraulic fluid is functionally connected with the third piston or else the first piston is functionally connected together with the third piston and the second piston is functionally connected with the reservoir for the hydraulic fluid. Owing to this form of embodiment, the consumption of material and the costs for development of the brake pedal simulator with three valves are reduced.

According to another embodiment of the invention, an aerating and de-aerating valve is provided on the reservoir, in particular above the fluid level provided for the hydraulic fluid. Thus, air is able to flow into the reservoir or escape from it to avoid over- or underpressure.

According to an additional embodiment of the invention, there is located an equalizing line between the reservoir and the first chamber section, between the first piston and the first valve. In this way, equalization of volume for the hydraulic fluid in the region of the first chamber section is made possible so that, hydraulic fluid in the first chamber section, which escapes in the course of operation of the brake pedal simulator, can be replaced from the reservoir. This equalizing line may preferably discharge directly before the first piston into the first chamber section in such a way that, by slight penetration of the first piston into the first chamber section, access to the equalizing line is already closed off. Thus, the path of the hydraulic fluid upon actuation of the first piston runs directly to the second or third piston and not through the reservoir.

Additionally, a pressure-determination means for measurement of the pressure of the hydraulic fluid in the chamber, in particular in the first chamber section, may be provided. The pressure-determination means preferably may in particular have an electrical pressure sensor which preferably is located in the chamber, for example in the first chamber section, for measurement of the pressure. Thus, the pressure of the hydraulic fluid, in particular during operation of the pedal simulator, can be monitored and optionally failure of the pedal simulator be detected.

The restoring means preferably has a spring and/or a rubber element located in particular in a closed airtight or open space, for the action on the second piston. A particularly low-cost restoring means can be obtained in this way.

The first piston and/or the second piston and/or the third piston preferably is designed as a piston rod.

According to one embodiment of the invention, the first piston is designed divided so that the first piston consists of a first partial piston and a second partial piston, and these two partial pistons are connected by an elastic element, preferably a piston spring. This embodiment has the advantage that at least some of the brake pedal restoring force need not be supplied by the spring of the restoring means by the second piston, but can be supplied by this elastic element within the first piston. For example, this also permits operation of the brake pedal simulator in which the first valve and the second valve are closed, and, hence, the working space for the first piston is provided only by the elastic element, and all of the restoring force is supplied by this elastic element. In this way, with suitable selection of the springs or other elastic elements in the first piston and in the second piston, it is possible to simulate a variety of response behaviors, for example “comfort” and “sport,” of the brake pedal. An additional advantage of this embodiment lies in that emergency operation, in which the brake system is operated currentless, and a direct hydraulic functional connection between the first piston and the third piston via the second valve is produced, is also made possible. Upon actuation of the brake pedal, at first only the free play of the first piston has to be overcome until the elastic element in the first piston blocks. Then, the full force of the first piston is transmitted through the hydraulic functional connection to the third piston and hence to the brake pressure transducer. In addition, this divided first piston makes it possible, including in a failure situation, with the first and second valve closed, for the operator's braking desire to be detected by the additionally enabled movement of the first partial piston. As a result, a pressure-determination unit for measurement of the pressure of the hydraulic fluid in particular in the first chamber section can also be dispensed with.

In this embodiment with a divided first piston, a path sensor for determination of the position of the first piston preferably is used, which, by a signal-transmitting element, for example a magnet, in the first part of the first piston, between brake pedal and elastic element, determines the position of this first part of the first piston. In this way, it is possible to correctly assess the operator's braking desire by determination of the path of the first part of the first piston.

In an additional embodiment of the invention, a throttle check valve is arranged between the first valve and the first piston. Thus, depending upon the adjustment of the throttle of the throttle check valve, the course of the pedal restoring force can be altered. The relation between pedal actuation force and pedal restoring force from the hydraulic pressure in the first chamber section can thus result in a variety of hysteresis curves, dependent upon the adjustment of the check valve.

According to another preferred embodiment of the invention, the first valve, the second valve and/or the third valve are arranged in a common valve block. The valve block may be incorporated as a unit in the pedal simulator, so that the more costly separate installation of the individual valves in the pedal simulator is avoided.

According to an additional preferred embodiment of the invention, the first valve, the second valve and/or the third valve, together with the container for hydraulic fluid, which forms the basic member of the brake pedal simulator and to which the first piston, the third piston, the restoring means and optionally the reservoir for hydraulic fluid may be attached, are arranged in a common housing as a brake pedal simulator block. In this way, the brake pedal simulator block, like a valve block, can be produced and built up as a unit.

According to another preferred embodiment of the invention, in addition to the first valve, the second valve and/or the third valve and the container for hydraulic fluid, which forms the basic member of the brake pedal simulator, the restoring means is also arranged in a common housing as a brake pedal simulator block. In this way, the brake pedal simulator block, like the valve block, can be produced and built up as a unit, the restoring means already being integrated into the brake pedal simulator block.

The invention in addition relates in particular to an electrohydraulic brake system for a motor vehicle having one of the brake pedal simulators according to the invention. The first piston of the brake pedal simulator in the brake system according to the invention preferably is mechanically coupled with the brake pedal. In addition, the chamber of the brake pedal simulator is limited by a third piston. There, the first section of the chamber extends between the first piston and the second valve and the third section of the chamber extends between the third piston and the second valve. In addition to this, the brake system according to the invention has a pressure transducer which is drivable by the third piston. The brake system according to the invention is designed in such a way that the first valve, during a first mode of operation of the brake system, which in particular is a brake-by-wire mode of operation, is open so as to develop, via the brake pedal simulator, a first functional connection between the brake pedal and the restoring means. In addition, the brake system according to the invention is designed in such a way that the second valve is closed during the first mode of operation so as to interrupt a second functional connection which is formed between the brake pedal and the brake pressure transducer when the second valve is open.

According to a further development of the invention, the brake system according to the invention is designed in such a way that the first valve, during a second mode of operation of the brake system, which in particular is an emergency mode of operation, is closed so as to interrupt the first functional connection and that the second valve is open during the second mode of operation so as to form the second functional connection.

According to another embodiment of the invention, the brake system comprises a sensor means for the determination of the position of the brake pedal and an electrical control and/or drive means for the brake pressure transducer, where the transducer, during the first mode of operation, is capable of actuation by the control and/or drive means as a function of the position of the brake pedal.

In the brake system according to the invention, the third valve preferably separates the third chamber section from the reservoir for the hydraulic fluid. In particular, it may be provided that the third valve is open during the first mode of operation, so as to permit the flow of hydraulic fluid out from the reservoir into the third chamber section. In addition, the third valve may be closed during the second mode of operation of the brake system, so as to separate the third chamber section from the reservoir and so prevent a pressure drop in the chamber, which would be caused by the flow of hydraulic fluid out from the third chamber section into the hydraulic fluid reservoir.

According to an additional embodiment of the brake system according to the invention, the reservoir has an aerating and de-aerating valve, in particular above the level provided for the hydraulic fluid.

The brake pressure transducer may in particular be a main brake cylinder, which preferably is designed in the form of a tandem main brake cylinder. In addition, the brake pressure transducer may be a combination of brake force amplifier and main brake cylinder.

According to another embodiment of the invention, connected to the brake pressure transducer is at least one, in particular hydraulic, brake circuit, by which the transducer is in functional connection with at least one wheel brake of a motor vehicle.

The brake system according to the invention preferably is an electrohydraulic brake system in which the brake pressure transducer is capable of actuation during the first mode of operation by the control and/or drive means as a function of the position of the brake pedal. In addition, during the second mode of operation, a movement of the first piston resulting from actuation of the brake pedal is transmitted by the hydraulic fluid to the third piston, thereby actuating the transducer.

The brake system according to the invention may in addition be operated in combination with a so-called recuperation brake. Recuperation brakes are used chiefly in hybrid and electric motor vehicles. There, an electric motor, which for example is a component of the drive train, is operated as a generator. The latter converts kinetic energy of the motor vehicle into electrical energy, whereby braking of the vehicle is effected. In the brake system according to the invention, it is advantageous that the brake pedal be decoupled from the brake pressure transducer during the first mode of operation. Thus, influences on the brake system which are produced by the recuperation brake are not transmitted to the brake pedal. Rather, in the brake system according to the invention, the customary brake feel continues to be transmitted to the operator even with additional use of the recuperation brake, because of the coupling between brake pedal and restoring means.

A further advantage of the brake system according to the invention consists in that it can be positioned at one and the same place in the vehicle for a variety of vehicle models, for example a vehicle with left-hand steering and a vehicle with right-hand steering, by use of possibly variously long hydraulic lines, whereby reduced production expenditure can be obtained according to the same-part principle.

The brake system according to the invention may in addition be operated as a passenger safety system for protecting the driver from injury in the foot space. For this purpose, for example after detecting an accident situation, with the expected deformation of the foot space, the brake pedal simulator is operated in the second mode of operation so that the first and third valve is closed, but the second valve is open, and by a control and/or drive means, preferably that which also actuates the brake pressure transducer in normal operation, the third piston is drawn out of the third chamber section, whereby the first piston is drawn into the first chamber section by the second functional connection and whereby the brake pedal is drawn into a position nearer the floor of the vehicle. Foot and leg injuries to the driver can thereby be minimized.

### DRAWINGS

The invention is described below in purely exemplary fashion by an advantageous embodiment and with reference to the accompanying drawing, wherein, in each instance in schematic fashion:

FIG. 1 shows a longitudinal section through a brake pedal simulator built into a brake system, where the brake pedal of the brake system is arranged in an unactuated starting position,

FIG. 2 shows the brake pedal simulator of FIG. 1 with the brake pedal arranged in a maximally actuated position,

FIG. 3 shows the brake pedal simulator of FIG. 1 having the first valve, the second valve and the third valve designed as a single 4/2-way valve,

FIG. 4 shows the brake pedal simulator of FIG. 1 having the first valve and the second valve designed as a single 3/2-way valve,

FIG. 5 shows a schematic representation of a brake pedal in the foot space of a vehicle,

FIG. 6 shows the brake pedal simulator of FIG. 2, with a detailed representation in which the first piston is designed as a divided piston with a spring element,

FIG. 7 shows the brake pedal simulator of FIG. 2, with a detailed representation in which a throttle check valve is arranged between the first valve and the first piston, and

FIG. 8 shows hysteresis curves that represent the relation between pedal actuating force and hydraulic pressure in the first chamber section with use of a throttle check valve.

### DETAILED DESCRIPTION

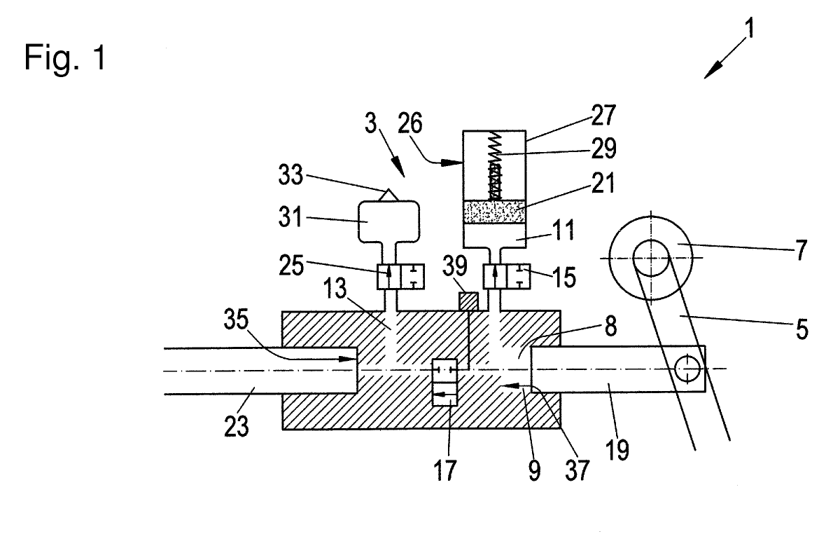

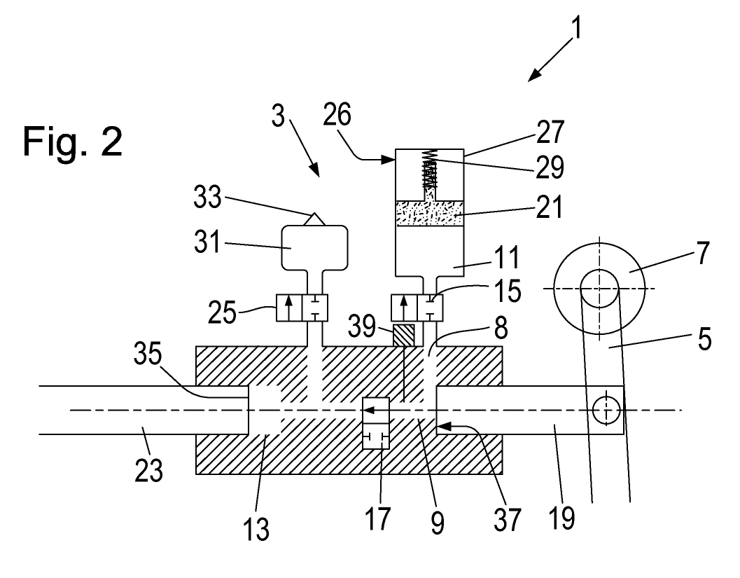

The brake system 1 shown in FIG. 1 and FIG. 2 has a brake pedal simulator 3, a brake pedal 5 and a pedal path sensor 7. The brake pedal simulator 3 has a chamber 8 filled with hydraulic fluid which comprises a first chamber section 9, a second chamber section 11 and a third chamber section 13. A first valve 15 and a second valve 17 are arranged in the chamber 8. Specifically, the first valve 15 separates the first chamber section 9 from the second chamber section 11, while the second valve 17 separates the first chamber section 9 from the third chamber section 13.

The first chamber section 9 is in addition limited by a first piston 19 so that the first chamber section 9 extends between the first piston 19 and both the first valve 15 and the second valve 17. A second piston 21 limits the second chamber section 11 so that the second chamber section 11 extends between the second piston 21 and the first valve 15. Further, a third piston 23 limits the third chamber section 13 so that the third chamber section 13 extends between the third piston 23 and both the second valve 17 and a third valve 25 which is arranged at the third chamber section 13.

The second piston 21 is in functional connection with a restoring means 26 which has a spring 29 arranged in a chamber 27 closed off airtight, by which the second piston 21 is acted upon. Additionally, the third piston 23 is in functional connection with a brake pressure transducer, not shown. Additionally, the third valve 25 separates the third chamber section 13 from a reservoir 31 for the hydraulic fluid. Arranged on the reservoir 31 above the fluid level provided for the hydraulic fluid is an aerating and de-aerating valve 33.

The brake system 1 also has a pressure-determination means 39 which includes a pressure sensor arranged in the first chamber section 9 and operable for determining the pressure in the first chamber section 9. As such, the fluid pressure, in particular during operation of the brake system 1, can be monitored and if necessary a malfunction can be detected.

In FIG. 1, as mentioned above, the brake pedal 5 is not actuated so that the third piston 23 is also arranged in its unactuated starting position, which is defined by a stop 35 for the third piston 23 formed by a diminution of the third chamber section 13. In contrast, in FIG. 2, the brake pedal 5 is maximally actuated for the production of a brake force, the first piston 19 striking on a stop 37 which is formed by a diminution of the first chamber section 9 so that the brake pedal 5 cannot be depressed further.

The brake system 1 can be operated in a first mode of operation which is a brake-by-wire mode of operation, and in a second mode of operation, a so-called emergency mode. In the following, the manner of operation of the brake system 1 during the first mode of operation is described first. Then, the manner of operation of the brake system 1 during the second mode of operation is indicated.

During the first mode of operation of the brake system 1, the first valve 15 and the third valve 25 are open, while the second valve 17 is closed. Thus, the first piston 19 and the second piston 21 are functionally connected together by the hydraulic fluid. In contrast, a functional connection between the first piston 19 and the third piston 23 is interrupted because of the closed second valve 17.

Upon actuation of the brake pedal 5, the first piston 19, which is mechanically coupled with the brake pedal 5, is moved from the starting position shown in FIG. 1 against the hydraulic fluid. Since the first piston 19 is in functional connection with the second piston 21, the spring force exerted by the spring 29 on the second piston 21 is transmitted to the first piston 19, and so a customary brake pedal feel is imparted to the vehicle operator, corresponding to the design of the spring 29. For actuation of the brake pressure transducer, which in turn actuates at least one brake circuit with wheel brakes connected thereto, the signal determined by the pedal path sensor 7 is supplied to an electrical control and/or drive means, not shown, which moves the third piston 23 out of its starting position shown in FIG. 1 into a position which depends upon the pedal path. So as to prevent an underpressure from occurring in the third chamber section 13 upon a movement of the third piston 23, hydraulic fluid is able to flow out of the reservoir 31 into the third chamber section 13 since the third valve 25 is open.

As soon as the brake pedal 5 is no longer actuated by the vehicle operator, the force exerted by the spring 29 on the second piston 21 is transmitted by the hydraulic fluid found in the first and second chamber section 9, 11 to the first piston 19 which causes the brake pedal 5 to be moved back into its starting position shown in FIG. 1. Accordingly, the third piston 23 can also be moved by the control and/or drive means back into its starting position shown in FIG. 1.

If, for example, the current supply is interrupted so that, for example, the pedal path sensor 7 and/or the electrical control and/or drive means are not functional, the brake system 1 is operated in the second mode of operation.

During the second mode of operation of the brake system 1, the second valve 17 is open while the first valve 15 and the third valve 25 are closed. Thus, a functional connection is obtained between the first piston 19 and the third piston, 23 during the second mode of operation, so that upon actuation of the brake pedal 5, a movement of the first piston 19 against the hydraulic fluid is transmitted directly to the third piston 23 and the brake pressure transducer is actuated. In addition, because of the closed first valve 15, the first piston 19 and the second piston 21 are decoupled from each other. In addition to this, it is ensured by the closed third valve 25 that when the brake pedal 5 is actuated during the second mode of operation, no pressure loss takes place in the first chamber section 9 and in the third chamber section 13. In this respect, it is insured by the closed first and third valves that the pedal force exerted is fully transmitted to the brake pressure transducer.

The first and third valves 15, 25 are preferably designed as currentless closed directional control valves, whereas the second valve 17 is preferably a currentless open directional control valve. In this way, it is ensured that the first, second and third valves 15, 17, 25, in case of current failure, assume their desired positions, and, therefore, the brake system 1 is sure to function even during the emergency mode of operation.

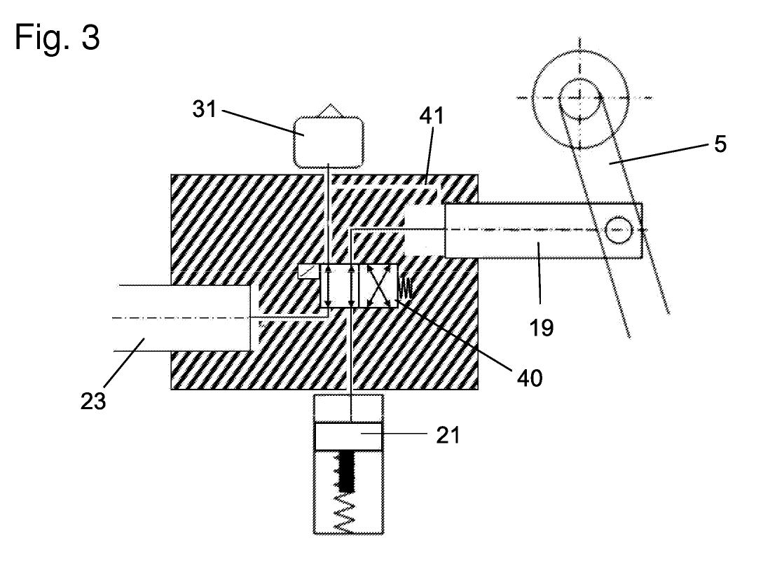

The brake system shown in FIG. 3 has a 4/2-way valve 40, which is able to perform the tasks of the first valve 15, the second valve 17 and third valve 25. In a first position of the 4/2-way valve, the latter is switched so that a first hydraulic functional connection exists between the first piston 19 and the second piston 21, as well as a second hydraulic functional connection between the reservoir 31 and the third piston 23. In a second position of the 4/2-way valve 40, the latter is switched so that a third hydraulic functional connection exists between the first piston 19 and the third piston 23 as well as a fourth hydraulic functional connection between the reservoir 31 and the second piston 21.

Additionally shown in FIG. 3 is an equalizing line 41, which produces a connection between the first chamber section 9, which is found between the first piston 19 and the 4/2-way valve 40, and the reservoir 31, by which hydraulic fluid can get from the reservoir 31 into the first chamber section 9 for the equalization of volume. This equalizing line 41 discharges directly before the first piston 19 into the first chamber section 9, so that access to the equalizing line 41 is already closed due to slight actuation of the first piston 19. In this way, when the first piston 19 is actuated, the path of the hydraulic fluid runs directly to the second piston 21 or third piston 23 and not through the reservoir 31.

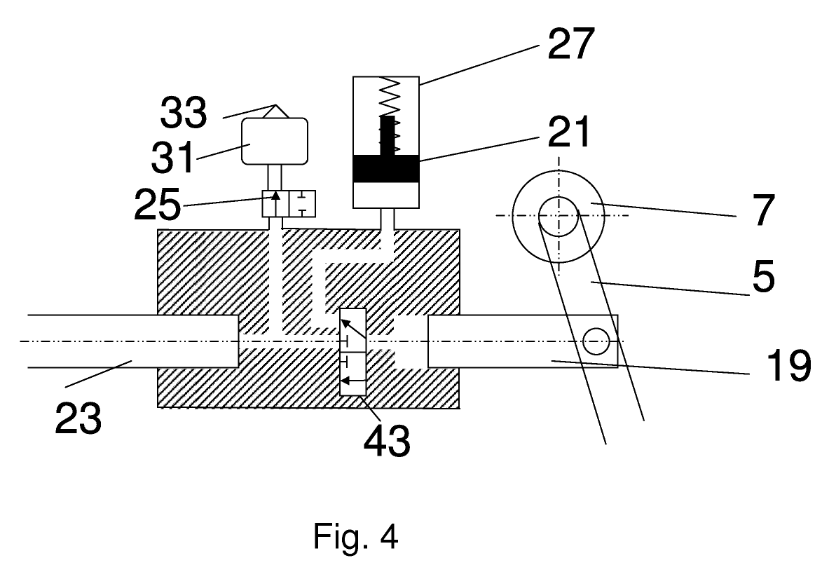

The brake system shown in FIG. 4 has a 3/2-way valve 43 which is able to perform the tasks of the first valve 15 and the second valve 17. In a first position of the 3/2-way valve 43, the latter is switched so that a first hydraulic functional connection exists between the first piston 19 and the second piston 21. In a second position of the 3/2-way valve 43, the latter is switched so that a second hydraulic functional connection exists between first piston 19 and third piston 23.

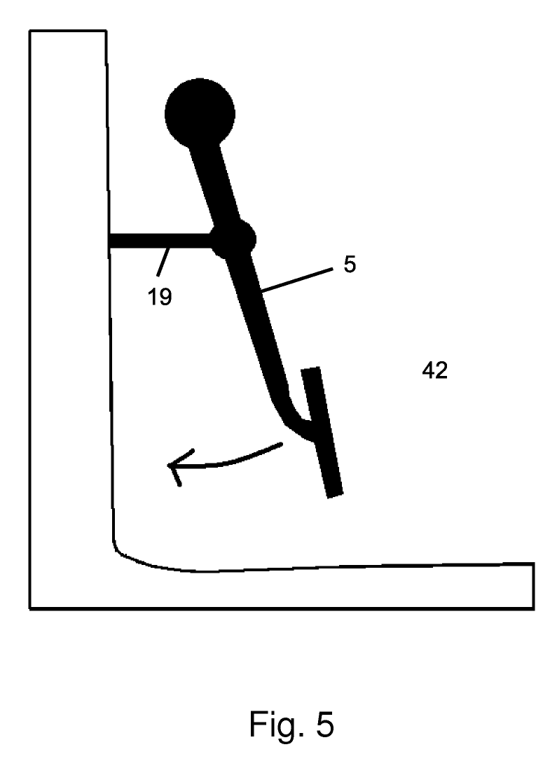

FIG. 5 shows the foot space 42 of a vehicle in which the brake pedal 5 is found. Owing to retraction of the piston 19 the brake pedal 5 draws back from the foot space 42 in the direction of the arrow.

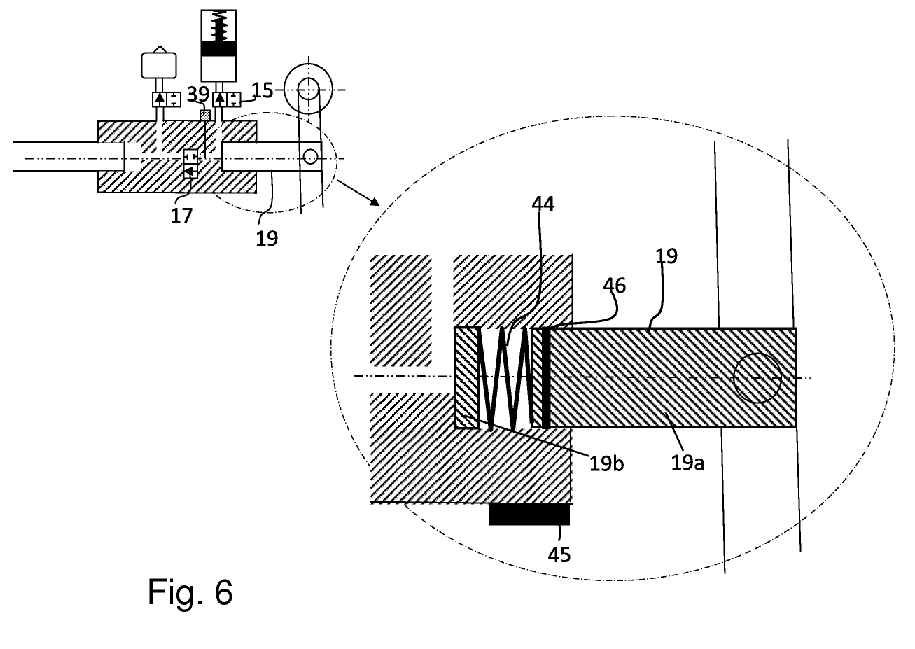

FIG. 6 shows the brake pedal simulator with a detailed representation in which the first piston 19 is designed divided, so that the first piston 19 consists of a first partial piston 19a and a second partial piston 19b, and these two partial pistons are connected by an elastic element 44, preferably a piston spring. In addition, a path sensor 45, for example an inductive path sensor, is shown, which determines the path of the first partial piston 19a by a magnet 46, which serves as a signal transmitter.

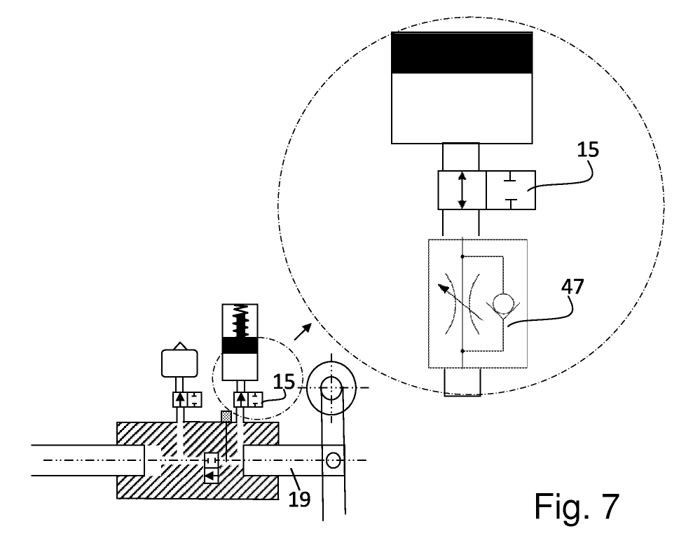

FIG. 7 shows the brake pedal simulator with a detailed representation in which a throttle check valve 47 is arranged between the first valve 15 and the first piston 19.

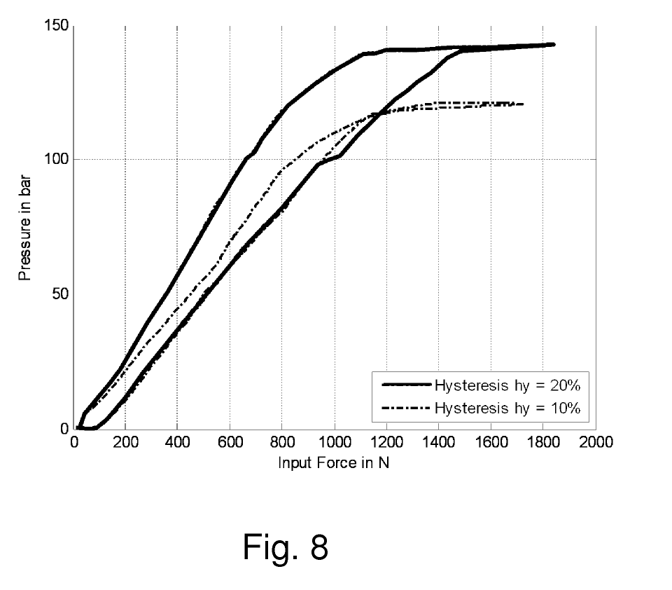

FIG. 8 shows hysteresis curves which represent the relation between pedal actuating force (x-axis) and hydraulic pressure in the first chamber section (y-axis) and thus the pedal restoring force when a throttle check valve is used. The solid line represents a course with fairly strong throttling by the throttle check valve and thus strong hysteresis, the broken line a course with weaker throttling and thus smaller hysteresis.

### LIST OF REFERENCE NUMERALS

1 Brake system
3 Brake pedal simulator
5 Brake pedal
7 Pedal path sensor
8 Chamber
9 First chamber section
11 Second chamber section
13 Third chamber section
15 First valve
17 Second valve
19 First piston
21 Second piston
23 Third piston
25 Third valve
26 Restoring means
27 Airtight space
29 Spring
31 Reservoir
33 Aerating and de-aerating valve
35 Stop
37 Stop
39 Pressure-determination means
40 4/2-way valve
41 Equalizing line
42 Foot space
43 3/2-way valve
44 Piston spring
45 Piston path sensor
46 Magnet
47 Throttle check valve

1. A brake pedal simulator for a brake system (1) of a motor vehicle having a chamber (8) filled with hydraulic fluid which is limited in particular by a first piston (19) capable of being coupled with a brake pedal (5) and by a second piston (21), and a restoring means (26) acting on the second piston for the production of a restoring force, wherein the chamber (8) has a first chamber section (9) and a second chamber section (11), wherein the first chamber section (9) extends between a first valve (15), in particular a currentless closed directional control valve, and the first piston (19), and wherein the second chamber section (11) extends between the first valve (15) and the second piston (21),
wherein the first piston (19) and the second piston (21) are functionally connected together by the hydraulic fluid when the first valve (15) is open so as to transmit the restoring force produced by the restoring means (26) to the first piston (19) upon a movement of the first piston (19) against the hydraulic fluid,
wherein the functional connection between the first piston (19) and the second piston (21) is interrupted when the first valve (15) is closed,
wherein the chamber (8) is limited by a third piston (23) which is provided for driving a brake pressure transducer of the brake system (1),
wherein the chamber (8) has a third chamber section (13) and a second valve (17), in particular a currentless open directional control valve, wherein the first chamber section (9) extends between the first piston (19) and the second valve (17), and wherein the third chamber section (13) extends between the second valve (17) and the third piston (23),
wherein the first piston (19) and the third piston (23) are functionally connected together by the hydraulic fluid when the second valve (17) is open so as to transmit a movement of the first piston (19) to the third piston (23), and
wherein the functional connection between the first piston (19) and the third piston (23) is interrupted when the second valve (17) is closed.

2. The brake pedal simulator according to claim 1, wherein the second valve (17) is closed when the first valve (15) is open, and wherein the second valve is open when the first valve is closed.

3. The brake pedal simulator according to claim 1 further including a pressure-determination means (39) having a pressure sensor that is operable to determine the hydraulic fluid pressure in at least the first chamber section (9) of the chamber (8).

4. The brake pedal simulator according to claim 1 wherein the restoring means (26) comprises a spring (29) acting on the second piston (21).

5. The brake pedal simulator according to claim 1 wherein the first valve (15) and the second valve (17) are arranged in a common valve block.

6. The brake pedal simulator according to claim 5 wherein the first valve (15) and the second valve (17) are designed as a single 3/2-way valve (43), so that in a first position of the 3/2-way valve (43) the first piston (19) and the second piston (21) are functionally connected together by the hydraulic fluid and in a second position of the 3/2-way valve the first piston (19) and the third piston (23) are functionally connected together by the hydraulic fluid.

7. The brake pedal simulator according to claim 1 wherein the first piston (19) includes a first partial piston (19a) and a second partial piston (19b), and wherein these two partial pistons are connected by an elastic element (44).

8. The brake pedal simulator according to claim 1 wherein a throttle check valve (43) is arranged between the first valve (15) and the first piston (19).

9. The brake pedal simulator according to claim 1 wherein a third valve (25) separates the third chamber section (13) from a reservoir (31) for the hydraulic fluid, wherein the third valve (25) is open when the second valve (17) is closed, and wherein the third valve (25) is closed when the second valve (17) is open.

10. The brake pedal simulator according to claim 9, wherein the first valve (15), the second valve (17) and the third valve (25) are arranged in a common valve block.

11. The brake pedal simulator according to claim 10 wherein the first valve (15), the second valve (17) and the third valve (25) are designed as a single 4/2-way valve (40), so that in a first position of the 4/2-way valve (40) the first piston (19) is functionally connected together by the hydraulic fluid with the second piston (21) and the reservoir (31) is functionally connected by the hydraulic fluid with the third piston (23), and in a second position of the 4/2-way valve the first piston (19) is functionally connected by the hydraulic fluid with the third piston (23) and the second piston is functionally connected by the hydraulic fluid with the reservoir (31).

12. The brake pedal simulator according to claim 9 wherein an equalizing line (41) for the equalization of hydraulic volume is provided between the reservoir (31) and the first chamber section (9).

13. A brake system for a motor vehicle having the brake pedal simulator (3) according to claim 1 wherein the first piston (19) is mechanically coupled with the brake pedal (5), wherein the brake system has a brake pressure transducer which is driven by the third piston (23), wherein the first valve (15) is open during a first mode of operation of the brake system (3) so that a first functional connection between the brake pedal (5) and the restoring means (26) is formed by the brake pedal simulator (3), and wherein the second valve (17) is closed during the first mode of operation so that a second functional connection is interrupted between the brake pedal (5) and the brake pressure transducer.

14. The brake system according to claim 13, further including a sensor means (7) for the determination of a position of the brake pedal (5) and an electrical control and/or drive means for the brake pressure transducer, wherein the brake pressure transducer is capable of actuation during the first mode of operation by the control and/or drive means as a function of the position of the brake pedal (5).

15. The brake system according to claim 13, wherein the first valve (15) is closed during a second mode of operation of the brake system (3) so as to interrupt the first functional connection, and wherein the second valve (17) is open during the second mode of operation so as to form the second functional connection.

16. The brake system according to claim 13 having a brake pedal simulator in which the first piston (19) includes a first partial piston (19a) connected by an elastic element (44) to a second partial piston (19b), and wherein the first valve (15) and the second valve (17) are closed during a third mode of operation of the brake system (1) so that the first chamber section (9) is closed and upon actuation of the first piston (19) the first partial piston (19a), under compression by the elastic element (44) is moved nearer to the second partial piston (19b).

17. The brake system according to claim 16, further comprising a piston path sensor means (45) for the determination of a position of the first partial piston (19a) and an electrical control and/or drive means for the brake pressure transducer, wherein the brake pressure transducer is capable of actuation by the control and/or drive means during the third mode of operation as a function of the position of the first partial piston (19a).

18. The brake system according to claim 15 having an electrical control and/or drive means which actuates the third piston (23) during the second mode of operation in such a way that the third piston (23) is drawn out of the third chamber section, whereby the first piston (19) is drawn into the first chamber section (9) by the second functional connection and whereby the brake pedal (5) is at least partially withdrawn from a foot space (42).

19. A brake pedal simulator for a brake system of a motor vehicle; comprising:
a chamber filled with hydraulic fluid and having first, second and third chamber sections;
a first piston having a first end disposed within said first chamber section and a second end coupled to a brake pedal;
a second piston having a first end disposed within said second chamber section and a second end;
a restoring mechanism exerting a restoring force on said second end of said second piston;
a third piston having a first end disposed within said third chamber section and a second end driving a brake pressure transducer;
a first valve operable in an open state to permit communication of the hydraulic fluid between said first and second chamber sections and in a closed state to interpret such fluid communication therebetween; and
a second valve operable in an open state to permit communication of the hydraulic fluid between said first and third chamber sections and in a closed state to interrupt such fluid communication therebetween;
wherein a first mode of operation is established when said first valve is open and said second valve is closed such that said restoring force produced by said restoring mechanism is transmitted to said first piston upon movement of said first piston against the hydraulic fluid while movement of said third piston is controlled independently of movement of said first piston, and wherein a second mode of operation is established when said first valve is closed and said second valve is open such that movement of said first piston results in movement of said third piston and said restoring force is not transmitted to said first piston such that a physical force exerted on said brake pedal is transmitted to said brake pressure transducer.

20. The brake pedal simulator of claim 19 wherein said first valve is a currentless closed directional control valve that shifts into its closed state when not supplied with electrical power, and wherein said second valve is currentless open directional control valve that shifts into its open state when not supplied with electrical power.

21. The brake pedal simulator of claim 20 further including a third valve operable in an open state to permit fluid communication of the hydraulic fluid between a reservoir and said third chamber section and in a closed state to interrupt such fluid communication therebetween, and wherein said third valve is a currentless closed directional control valve that shifts into its closed state when not supplied with electrical power.

22. The brake pedal simulator of claim 19 wherein the first and second valves are integrated into a single 3/2-way valve that is operable in a first position to permit fluid communication between said first and second chamber sections while inhibiting fluid communication between said first and third chamber sections so as to establish said first mode of operation, wherein said 3/2-way valve is operable in a second position to permit fluid communication between said first and third chamber sections while inhibiting fluid communication between said first and second chamber sections so as to establish said second mode of operation, and wherein said 3/2-way valve shifts into its second position when not supplied with electrical power.

23. The brake pedal simulator of claim 19 further including a throttle check valve arranged between said first chamber section and said first valve.

24. The brake pedal simulator of claim 19 further including a reservoir of hydraulic fluid and a equalizing line providing fluid communication between said reservoir and said first chamber section.

25. The brake pedal simulator of claim 19 wherein said first piston includes a first partial piston coupled to said brake pedal, a second partial piston disposed in said first chamber section, and a piston spring disposed between said first and second partial pistons.
